(19) United States
(12) Patent Application Publication
(10) Pub. No.: US 2024/0108983 A1
(43) Pub. Date: Apr. 4, 2024

(54) CONTROLLING A USER INTERFACE

(71) Applicant: KING.COM LIMITED, St. Julians (MT)

(72) Inventors: Chloe Dunn-Asselin, Stockholm (SE); Alexandra Carmichael, Stockholm (SE); Korneel Guns, Stockholm (SE); Kyle Bardiau, Stockholm (SE); Andrew Mcatominey, Stockholm (SE)

(21) Appl. No.: 17/957,801

(22) Filed: Sep. 30, 2022

(51) Int. Cl. A63F 13/537; A63F 13/55; A63F 13/69

(52) U.S. Cl. CPC A63F 13/537; A63F 13/55; A63F 13/69; A63F 13/2145

(57) ABSTRACT

A computer device which is configured to provide a computer game responsive to user inputs, the computer device having a user interface comprising a display which is configured to display an initial game board of the computer game comprising user actuatable game elements and an avatar element at an initial avatar location of the game board. The gameboard includes an activation element on the game board. An activation condition from an interacting event with the activation element is detected and, responsive to the detection of the activation condition, a path segment extending from the avatar location to a next location on a predetermined path is unlocked. If the path segment is in a first state which permits movement of the avatar element from the avatar location to the next location, the avatar element is automatically moved from the avatar location to the next location without detecting further user input.

### FIELD OF THE INVENTION

The present invention relates to controlling a user interface responsive to user engagement with displayed elements on the interface of a computer device.

### BACKGROUND OF THE INVENTION

In the field of computer-implemented games, there are many technical challenges facing the designer of such games when considering how the user interface is to be controlled in the context of computer devices available to play the game.

A particular challenge is that of user engagement. Engagement involves designing gameplay to be engaging and rewarding to players. This typically requires games to be easily understood at their simplest or introductory levels, providing rewarding gameplay with quite simple game mechanics, but becoming progressively more challenging so that players are not bored, but remain engaged and develop rewarding skills. Effective engagement requires various forms of feedback to reinforce player sense of success and accomplishment.

An existing type of match-three game is a so-called “switcher” game. A match-three game is a type of casual puzzle game where the player is required to find patterns on a seemingly chaotic game board comprising tiles supporting user selectable game elements. The player then has to match three or more of the same type of game element on the game board and those matched elements then disappear. In a switcher game, the player switches place of adjacent game elements on the game board so that one or both of them create a chain of at least three adjacent game elements of the same type. Those matched game elements then disappear. The game board is then repopulated with game objects.

Another existing game-type is a “clicker game.” A “clicker game” is a type of casual puzzle game where the player is required to find patterns on a seemingly chaotic board. The player then has to match two or more of the same type of game element on the game board and those matched elements are then removed from the board. The player matches adjacent game elements of the same type by selecting one or more of the game elements in a group of matching elements.

A further existing game-type is a “linker game.” In this game, the user aims to remove game elements from the gameboard by linking groups of three or more matching elements. The user can select the elements to link by, for example, dragging their finger over the elements on a touch screen and then releasing their finger to select the linked element. Alternatively, the user may click on the elements they wish to link and then actively select a completion button to trigger their selection.

In games of the above type of game mechanic, certain game elements are provided on tiles which have additional properties compared with “normal” game elements which can be switched (clicked/linked) and are then removed. Such game elements are often referred to as booster game elements (or simply ‘boosters’) because they enhance game play, for example they may be triggered, and when triggered they remove additional game elements from the game board according to different removal policies associated with different booster game elements. Booster elements include for example line blasters, column blasters, bombs, fish etc.

The game also implements several different kinds of so called “blockers”. Blockers (also referred to herein as blocking elements) are game elements that are in the way for the player when wanting to make matches on different areas of the gameboard. Blocking elements are unresponsive to direct user engagement, but may be removed in certain conditions. Blocking elements may be removed by making a match adjacent a blocking element, or by the action of a booster game element which has been triggered.

Certain games provide so-called ‘path’ related features to increase user engagement and provide a sense of accomplishment. Reference is made to ‘Candy Crush Friends Saga: Heart Mode’, which is described in our patent application U.S. application Ser. No. 15/939,488. In embodiments of the heart mode feature, the user or player provides user input that directly interacts with a special ‘heart’ element. The heart element moves along a predetermined path upon receipt of a qualifying user input.

Further reference is made to a game entitled: ‘Disney Pop Town’, which is an example of a switcher game in which an objective is to direct an avatar element along a path. In some examples of the Pop Town game, blocker elements lie along a predetermined path and the user removes blocker elements to allow the avatar to move along the path.

The present application is directed to a computer device and method which provides an enhancement to a path related feature to enable a user to readily engage with a user interface of the computer device.

This patent specification describes not only various ideas and functions, but also their creative expression. A portion of the disclosure of this patent document therefore contains material to which a claim for copyright is made and notice is hereby given: Copyright King.com Limited 2019 (pursuant to 17 U.S.C. 401). A claim to copyright protection is made to all screen shots, icons, look and feel and all other protectable expression associated with the games illustrated and described in this patent specification.

The copyright owner has no objection to the facsimile reproduction by anyone of the patent document or the patent disclosure, as it appears in the Patent and Trademark Office patent file or records, but reserves all other copyright rights whatsoever. No express or implied license under any copyright whatsoever is therefore granted.

### SUMMARY OF THE INVENTION

In existing games, a gameboard layout is presented to a user at the commencement of each level of a game with which a user is to engage. The layout of a gameboard is defined in gameboard level data. Each gameboard comprises multiple gameboard locations which may be arranged in a rectangular array, or in any other conveniently displayable form for a user to engage with the gameboard. In some gameboards, all gameboard locations may be associated with a gameboard tile, capable of supporting a user selectable gameboard element or some other kind of game element such as a booster or blocker.

According to an aspect of the invention, there is provided a computer device configured to provide a computer game responsive to user inputs, the computer device having:
a user interface comprising a display which is configured to display an initial game board of the computer game comprising user actuatable game elements and a user input detection component configured to detect user input of a user move when a user engages with one of the user actuatable game elements, the display further configured to display an avatar element at an initial avatar location of the game board, and at least one activation element on the game board;
a processor configured to receive the detected user input of the user move and to detect an activation condition from an interacting event with the activation element and, responsive to the detection of the activation condition, to unlock a path segment extending from the avatar location to a next location on a predetermined path;
the processor further configured to determine that the path segment is in a first state which permits movement of the avatar element from the avatar location to the next location, and to cause the avatar element to move from the avatar location to the next location without detecting further user input.

In some embodiments, the processor is configured responsive to the detected user input of the user move to detect a match game condition of at least three adjacent matching user actuatable game elements and to control the user interface to remove the at least three game elements from the display and provide on the display replacement user actuatable game elements.

In some embodiments, the processor is configured to detect an interacting event with the activation element which comprises a match game condition of user actuatable game elements at least one of which is adjacent the activation element.

In some embodiments, the processor is configured to detect an interacting event which is created by game code executed by the processor which generates a direct interaction with the activation element.

In some embodiments, the display is configured to display a second activation element and wherein the processor is configured to detect a second activation condition from an interacting event with the second activation element, the processor further configured to unlock a second path segment extending from the next avatar location to a subsequent avatar location and to move the avatar element from the next location to the subsequent location on determination that the second path segment is in the first state.

In some embodiments, the processor is configured to unlock path segments to form the predetermined path from the initial avatar location to an endpoint location of the predetermined path. In such an embodiment, the processor may be configured to generate at the endpoint location of the predetermined path a portal on attainment of which by the avatar element a new game component is rendered on the display.

In some embodiments, the activation element comprises multiple activation layers, each of which is removed by an interacting event, wherein the activation condition is detected when all of the multiple activation layers have been removed.

In some embodiments, the processor is configured to render the predetermined path so as to be visually apparent on the display. In such an embodiment, an unlocked path segment may have a different visual appearance from a path segment of the predetermined path that has not yet been unlocked.

In some embodiments, the processor is configured to render on the display an indication of a direction in which the avatar element will move from its current location to a next location.

In some embodiments, the processor is configured to render the activation element on the display with an appearance which differs on removal of layers from the activation element.

In some embodiments, the processor is configured to remove the activation element from the game board when the activation condition is met.

In some embodiments, the processor is configured to detect that the unlocked path segment comprises a user actuatable game element and to switch the location of the user actuatable game element on the unlocked path segment with the avatar element in order to move the avatar element along the path segment.

In some embodiments, the processor is configured to provide the replacement user actuatable game elements by a refill mechanism in which game elements adjacent the locations of removed elements in a direction determined by a predetermined physics move into the spaces left after removal of the elements and replacement user actuatable game elements are refilled from the edge of the game board according to the predetermined physics.

In some embodiments, the computer device comprises a computer store holding tile data for each of a plurality of tiles supporting the game elements, including one or more activation element of the game board, the tile data designating a tile location of each tile on the game board and an indication that tiles on the predetermined path constitute path segments. In such an embodiment, the tile data may comprise attributes of the tile, wherein the attributes include one or more characteristic of a game element supported by the tile, wherein the game elements include one or more activation element.

In some embodiments, the processor is configured to determine that the path segment is not in the first state by detecting a blocker on the unlocked path segment.

In some embodiments, display of the initial game board of the computer game comprises displaying a first portion of the game board, and wherein the processor is configured to determine that the avatar element has moved from the avatar location to a boundary gameboard location at an extreme of the first portion of the gameboard and, in response, to display a second portion of the gameboard.

In some embodiments, the processor is configured to detect that a location on the unlocked path segment comprises an actuatable game element and a background tube element and to move the avatar element along the unlocked path segment without switching the location of the actuatable element.

According to a second aspect of the invention there is provided a computer-implemented method of providing a computer game responsive to user inputs, the method comprising:
displaying, on a user interface of a computer device, an initial game board of the computer game comprising user actuatable game elements and
detecting, via a user input detection component, a user input of a user move when a user engages with one of the user actuatable game elements;
displaying an avatar element at an initial avatar location of the game board, and at least one activation element on the game board;
receiving, at a processor of the computer device, the detected user input of the user move;
detecting, via the processor, an activation condition from an interacting event with the activation element;
responsive to the detection of the activation condition, unlocking a path segment extending from the avatar location to a next location on a predetermined path;
determining, via the processor, that the path segment is in a first state which permits movement of the avatar element from the avatar location to the next location; and
causing, via the processor, the avatar element to move from the avatar location to the next location without detecting further user input.

According to a third aspect of the invention there is provided a non-transitory computer-readable medium on which are stored computer readable instructions which when executed by a processor of a computer device cause the processor to implement the above-described method.

### BRIEF DESCRIPTION OF THE DRAWINGS

For a better understanding of the present invention and to show how the same may be carried into effect, reference will now be made by way of example to the accompanying drawings in which:

FIG. 1 shows a highly schematic diagram of a computer system architecture.

FIG. 2 is a graphical representation of a level in the Candy Crush game.

FIG. 3 shows a graphical representation of an exemplary gameboard, demonstrating a refill procedure.

FIG. 4 shows a highly schematic diagram of a computing device.

FIG. 5 is a highly schematic diagram of computer-related architecture to implement an avatar path feature.

FIG. 6 is a highly schematic diagram that represents a refill mechanism.

FIG. 7a is a first portion of a flowchart that represents an exemplary gameplay sequence for a level in the Candy Crush game that implements an avatar path feature.

FIG. 7b is a second portion of the flowchart according to FIG. 7a.

FIG. 8 shows an exemplary level of the Candy Crush game in which an avatar path is implemented.

FIG. 9a shows an exemplary tile data structure according to some embodiments.

FIG. 9b shows an exemplary element database according to some embodiments.

FIG. 10 shows an exemplary level design user interface for configuring a gameboard comprising an avatar path.

FIG. 11 shows an exemplary level design user interface representing a multi-gameboard level.

FIG. 12 shows an exemplary level design user interface representing a tube feature of the avatar path.

FIG. 13 shows an exemplary level design user interface representing a camera change feature of the avatar path.

### DETAILED DESCRIPTION OF THE INVENTION

The present disclosure provides a computer device configured to provide a game to a user and in particular to address a technical problem of increasing user engagement in the context of a matching game, such a switcher, clicker or linker.

The game has a gameboard with gameboard locations at which tiles are represented. The status of game board locations is defined in a gameboard layout, which may be for example part of level data for a game level stored in computer memory. A new special game objective is referred to as the ‘avatar path’ herein. The avatar path game objective is implemented by introducing new assignable attributes to tiles of a gameboard, and introducing a plurality of new game elements which may be located at tiles of the gameboard. The avatar path feature and its implementation by a processor of a computing device are described in more detail in context of the embodiments provided later herein.

The terms ‘user’ and ‘player’ are used interchangeably throughout this document and no specific meaning is intended using one or the other unless the context suggests otherwise.

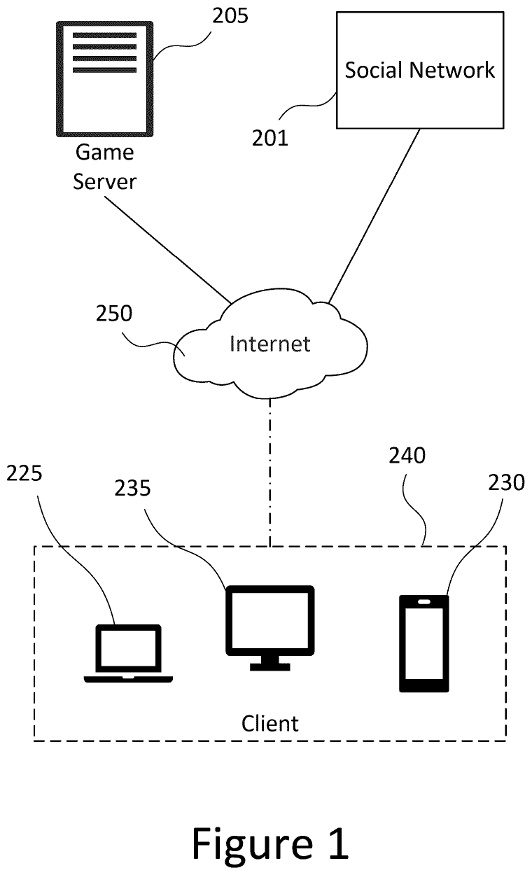

FIG. 1 portrays an exemplary overall environment in which the computer device of the present invention can be utilized as a client device. A virtual game is stored on, for instance, a game server 205. The virtual game is to be played on the client device 240, such as a computer 235, 225 or a smartphone or other handheld device 230. The client device 240 can also be a kiosk, arcade gaming station, smart TV or other device with computing capabilities, input devices, and a screen that can present the game to a user. The client device communicates with the game server 205 and a social network server 201, for instance through the Internet 250 or other network. It should be understood that the social network server 201 and the game server 205 do not have to be located in different places, they could be on the same server or on a plurality of servers located in different locations. People skilled in the art will understand that other devices than the exemplary ones listed can also be used without departing from the scope of the invention.

The computer device may have a user interface allowing a user to interact with it in different ways depending on the capabilities of the client device 240 which the user is accessing the game with. A user can interact with the game through using a touch screen where the user can select and/or move elements on the game board with a finger or for instance with a stylus. The game can also be played with a pointing device such as a mouse or other interaction devices such as keyboard while the game is displayed to a user on a separate display of the user interface.

Mobile devices may have a touch screen interface where the player can interact with the game using a finger or a pointing device such as a stylus. Some mobile devices have hard keys that complement the touch screen interface. Such hard keys may be in the form of a button or in the form of a joystick type of interaction.

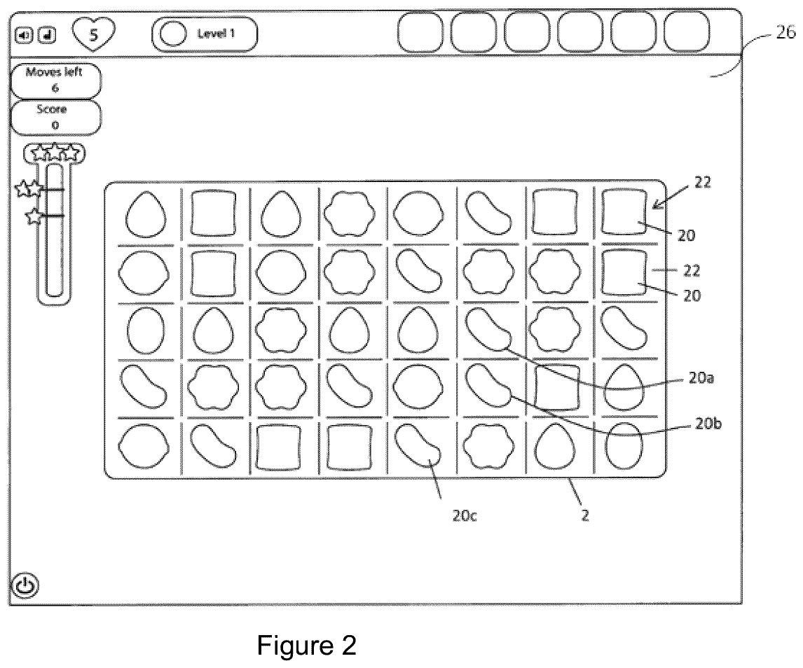

FIG. 2 shows a display of a known version of a match 3 switcher game called Candy Crush Saga™. FIG. 2 illustrates a game board 2 with a plurality of game elements 20 provided on a user interface 26 of a computer device. The game elements are each of six different shapes and colours. Each game element is supported by a tile 22. In some embodiments, the tiles are not readily visible to a player of the game—the game elements are the main focus for a player. However, the tiles may govern characteristics of the game elements which are visible to a player as will be described in more detail later.

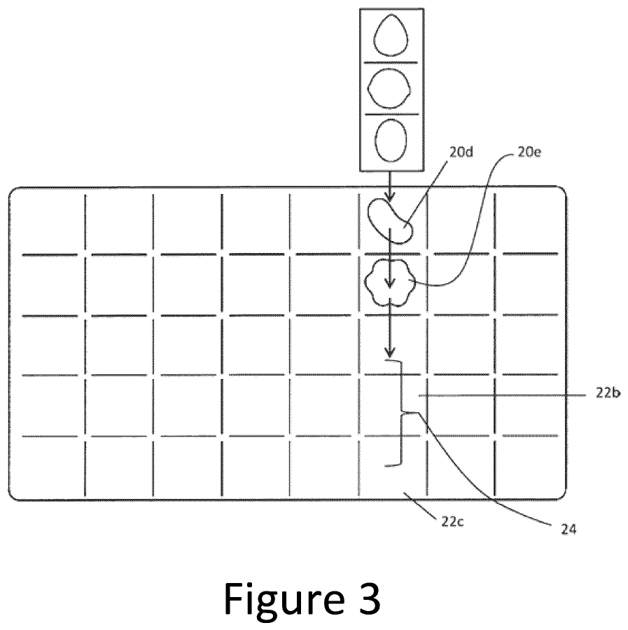

In the known version of the match 3 switcher game, the aim of the game is to swap game elements in the shape of candies with each other to make moves on the game board. To gain points the player has to make moves that create matches of at least three of the same candy. In doing so, the player gains points and the matched candies are removed. As a result, new candies are generated to fill any vacancies created. New candies may for example appear to fall in place from the top of the gameboard, but other effects are possible. Assume in FIG. 2 that game element 20c is moved one place to the right to form a three-line match with game elements 20a and 20b. Turning now to FIG. 3, this has the effect of game board elements 20a, 20b and 20c “disappearing”, creating a visual effect (animation) on the screen to indicate the disappearance, such as a minimal explosion effect denoted 24 in FIG. 3. The two game elements which were directly above game elements 20a will now fall downwards into the spaces created by the removal of game elements 20a, 20b and 20c. Thus, game element 20e will end up at the location of tile 22c, and game element 20d will end up at the location of tile 22b. In addition, three new game elements are generated and fall downwards into the game board to fill the remaining three tiles above tile 22b. In existing games, the newly generated game elements may be generated at random. The user then has a new game board on which to play a subsequent move. Note that in this case, the new game board has the same gameboard layout, but is populated by new game elements. Game elements may be of different types, and may include so-called booster game elements which enhance game play for a user. Other elements are blocking elements or ‘blockers’ which prevent a user from making a move or progressing.

Some blocking elements may be multi-layer blocking elements. These blockers have a predefined number of layers which the user has to remove in order to remove the whole blocker from its supporting tile. A single layer is removed from the multi-layer blocker when a match-3 condition is satisfied adjacent to the multi-layer blocker, or when a triggered booster element acts on the blocker. For such blockers, the blocking element is only removed fully when the final layer of the blocker is removed from the gameboard, when a blocking element removal condition is satisfied.

The blocking element removal condition may be satisfied if the blocking element comprises a last layer of a multi-layer blocking element, the other layers of the blocking element having previously been removed from the gameboard in one or more prior blocking element layer removal condition.

Some blocking elements may be unresponsive to element matches and other events that would otherwise cause removal of an element or a layer thereof from a gameboard. Such blockers may also be referred to herein as indestructible walls, or non-removable walls.

As explained more fully herein, the present disclosure relates to a computer device which is configured to provide further ways in which gameplay may be enhanced for a user by modifying the game board layout itself during game play.

The computer device and its operating modes described herein can be deployed in many different gameplay architectures. For example, a computer device can be configured by a computer game executed on the device. The game may be implemented as a computer program (e.g. game code) that is stored locally in the memory of a PC, games console, tablet or mobile telephone or other computing device. The game can be implemented as a computer program that is stored and runs entirely on one of many processors in a remote server, and data streams or updates are supplied to the client device (e.g. tablet, smartphone, etc.) to enable the client to render and display graphics and sounds.

Another possible infrastructure is a hybrid one, in which back-end servers handle some elements of the gameplay, and for instance a Java game applet is provided to client devices and it is the locally running Java applet that configures the client device to generate the graphics/sounds/user interaction for gameplay on the player's client device. Some data may be fed back to the back-end servers to enable scoring, interaction with other players and cross-platform synchronisation.

In implementations where some or all elements of game code are executed on a remote server, users may be able to share their gaming experiences with other users. They may, for example, be able to share the scores they have achieved in a level with other players, which may be used to generate a leader board. Users may be able to choose which other users to share their scores with, for example their friends on a social media platform such as Facebook. This gives a social aspect to the game.

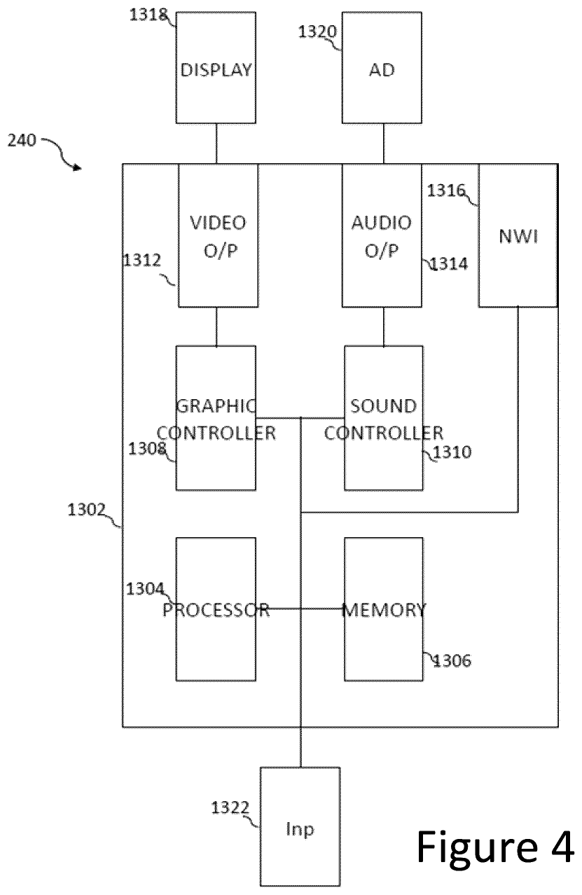

A schematic view of the user or computing device 240 according to an embodiment is shown in FIG. 4. The user device has a controller 1302. The controller 1302 may have one or more processors 1304 and one or more memories 1306. The controller 1302 is also shown as having a graphics controller 1308 and a sound controller 1310. It should be appreciated that one or other or both of the graphics controller 1308 and sound controller 1310 may be provided by the one or more processors 1304. Other functional components may also be implemented by suitable circuitry or computer code executed by the one or more processor 1304.

The graphics controller 1308 is configured to provide a video output 1312. The sound controller 1310 is configured to provide an audio output 1314. The controller 1302 has a network interface 1316 allowing the device to be able to communicate with a network such as the Internet 250 or other communication infrastructure.

The video output 1312 may be provided to a display 1318. The audio output 1314 may be provided to an audio device 1320 such as a speaker and/or earphones(s).

The device 240 may have an input device 1322. The input device 1322 can take any suitable format such as one or more of: a keyboard, mouse, touch screen, joystick or game controller. It should be appreciated that the display 1318 may in some embodiments also provide the input device 1322, for example, by way of an integrated touch screen. The functional components of the controller 1302 are configured to communicate with each other via an interconnect such as a bus or any other suitable interconnect and/or by point-to-point communication.

It should be appreciated that, in some embodiments, the controller 1320 may be implemented by one or more circuits, at least in part. It should be appreciated that embodiments may be deployed in different system architectures. For example, the computer device may be configured by a computer game that is stored in the memory 1306 of the user device 240. However, when online, the server 205 may handle some elements of the game in some embodiments, as previously described.

In some embodiments, a computer game may be implemented as a computer program that is stored in a memory system, for example the server 205, and which runs on the processor of the game server. Data streams or updates are supplied to the client device 240 to allow the user device 240 to render and display graphics and sounds in a browser of the client device 240.

### Avatar Path Overview

An overview of the avatar path feature is now provided. At the highest level, the avatar path feature implements an avatar game element on a first tile (or spawn tile) of the gameboard, and a path end (or portal) element on a second tile of the gameboard. One or more intermediate tile may be assigned as a ‘path tile’, the intermediate path tiles forming an unbroken route or path through tiles of the gameboard, starting at the first tile and ending at the second tile of the gameboard. The objective at the user end may be to guide the avatar element along the path, from the first tile to the second tile via the intermediate path tiles. The user may be required to ‘unlock’ path tiles, or path segments of one or more path tile, by satisfying a particular in-game trigger condition in order to guide the avatar element along the path. Game mechanisms and trigger conditions that enable the user to guide the avatar element are described later herein, in particular with reference to special game elements and tile attributes.

A first special game element may be the avatar game element. The avatar game element may be provided on a predefined ‘spawn’ tile of a gameboard. In context of a switcher game, the avatar element may not be switchable by direct user input indicating a switch with a game element in an adjacent tile. Instead, the avatar element may automatically move by switching with an element that lies in an adjacent tile when the tile attributes of that adjacent tile satisfy one or more condition.

Tiles may be assigned a ‘path tile’ attribute. Path tiles may also be separated into one or more path segment. Path tiles may initially be provided in a locked state, wherein the avatar element does not switch with elements in an adjacent locked path tile. A user may, by satisfying an in-game trigger condition, cause unlocking of one or more path tile. For example, satisfaction of a first trigger condition may cause unlocking of a first segment of the avatar path. The avatar element may be capable of switching with elements located in an adjacent unlocked path tile in order to move along the path. A whole path may comprise one or more path segment. For the whole path between the spawn tile and the portal tile to be unlocked, one or more trigger condition may need to be satisfied to unlock one or more corresponding path segment. The trigger condition by which a path segment is unlocked may be associated with a second special game element, referred to herein as an ‘activator’ element.

One or more activator element may be located on one or more corresponding tile of the gameboard. The activator element may be associated with a trigger condition which causes one or more locked path tile to be unlocked. The trigger condition associated with the activator element (referred to herein as the activator condition) may be met by destroying or removing the activator element from the gameboard. This can be achieved, for example, when a match condition comprising an element on a tile adjacent to the activator element is satisfied.

Other examples of in-game actions that may cause removal of an activator element (or a layer thereof) are now described. An action that causes removal of an activator element or layer thereof from the gameboard may be referred to as a ‘qualifying action’ (or interacting event) for the purposes of the following description. Qualifying actions may include a regular match condition comprising a game element in a tile adjacent to a tile comprising an activator element and a direct impact by a booster element event.

Booster element events may include colour bomb activation events, striped booster candy events, wrapped candy events, fish booster events, jelly cake explosion events, and combined booster element events. As noted above, only a direct impact by an instance of the above-mentioned booster events may constitute a qualifying action. It will be appreciated that booster events that act on (e.g. remove) game elements in tiles adjacent to an activator element may not constitute qualifying actions. The specific game mechanics of the booster elements referred to above are described later herein.

As described above an avatar path may be segmented, and satisfaction of a first activator condition corresponding to a first activator element may cause only a first segment of path tiles to be unlocked. For this reason, a plurality of activator elements may be provided on the gameboard. Alternatively, or additionally, an activator element may have a plurality of layers, such that an activation condition may be triggered more than once in respect of the same activator element. That is, a layer may be removed from the activator element each time the associated activation condition is met, until all layers are removed, at which point the activator element is destroyed or removed.

When a new path segment is unlocked, an avatar element may automatically, that is, without direct user input, travel along the tile or tiles of the path segment by switching with game elements that are provided in a next adjacent path tile. It will be appreciated that, for a ‘next path tile’ to be determined, an order of path tiles within the avatar path may be defined during a level design stage. In other examples, each path tile may be associated with a direction indicator, the direction indicating a direction in which the next path tile is located relative to the current position of the avatar element, and therefore which of the tiles adjacent to the avatar element is the ‘next’ path tile.

The avatar element may not be capable of progressing along the avatar path if an element in a next path tile is unswitchable, e.g., a blocker element. This may be true even if the next path tile is unlocked. Other in-game conditions may be satisfied to remove blocker elements that lie on the path. The progression of the avatar element along the avatar path depends on the unlocked state of the next path tile, and the switchable nature of elements in the next path tile.

A portal element may be provided in a tile located at the end of the avatar path. The game objective, or one of a plurality of game objectives within a level may be to unlock all path tiles in the avatar path and remove any blocker or otherwise non-switchable element lying on a path tile such that the avatar may progress along the unlocked avatar path to the portal.

Practical implementation of the above features by a processor of a computing device running a game program is described in more detail later herein.

### Functional Components

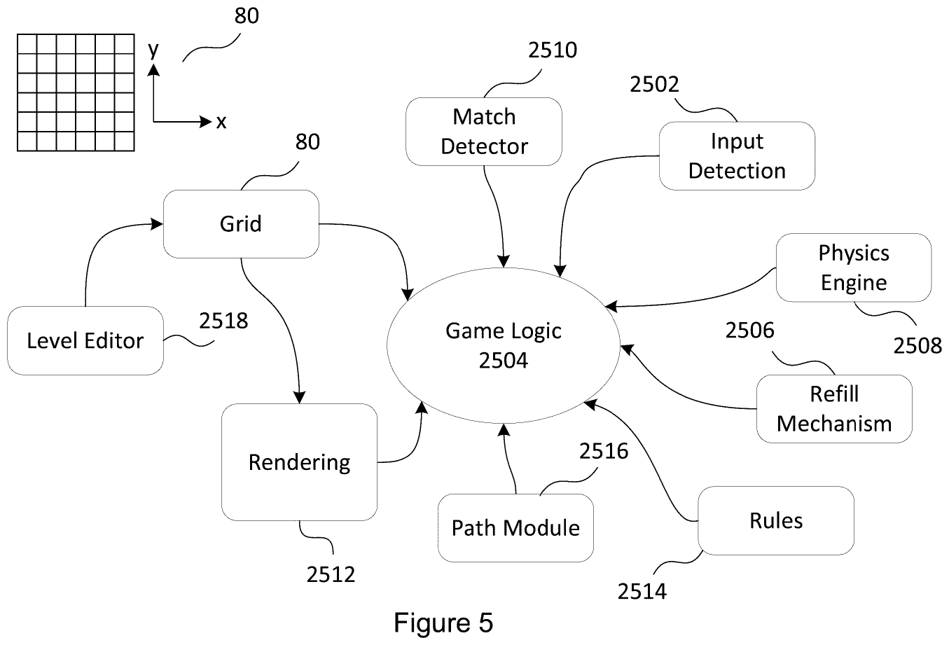

FIG. 5 shows a schematic representation of the functional components of an embodiment of a computer device, the computer device configured to implement an avatar path game objective and its associated game mechanics. Input detection 2502 captures the user input and feeds the input to the game logic 2504. The user input can be provided via any suitable user input device, such as those described above. In the context of the game, this user input can be used in a game view to indicate which game objects have been selected by a user, and thus to indicate the blocks to be switched and checked for adjacent matching blocks. Note that the term ‘blocks’ is used interchangeably herein to denote game elements or game objects. The game logic 2504 processes the information provided by the user input. The game logic 2504 may then determine if a valid selection has been made, and what the outcomes of the selection should be.

The rendering component is used to render the gameboard 2 to the user. It renders the game elements on the gameboard 2. Each time a game element moves tile location, for example, during a switch to make a match in a switcher game, or in gameboard refill, the rendering block is used to render this movement visible to the user on the display 1318 of the user device 240.

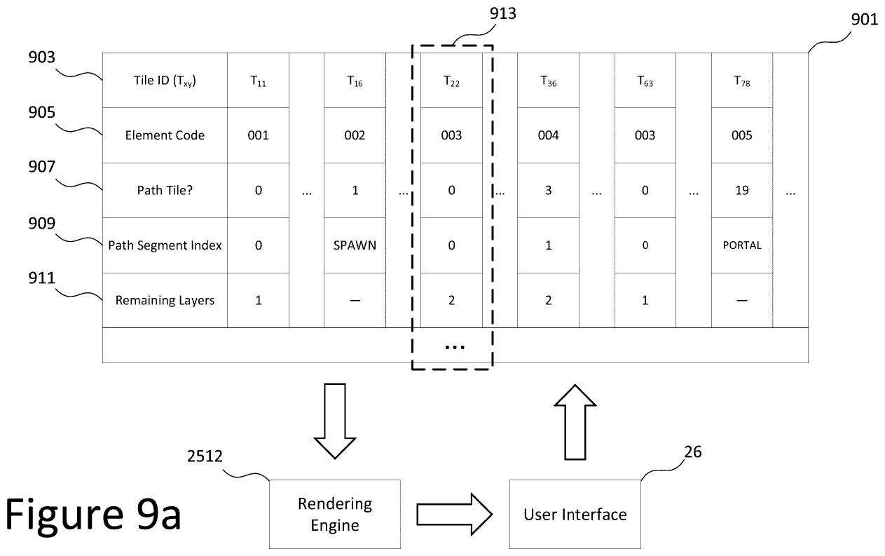

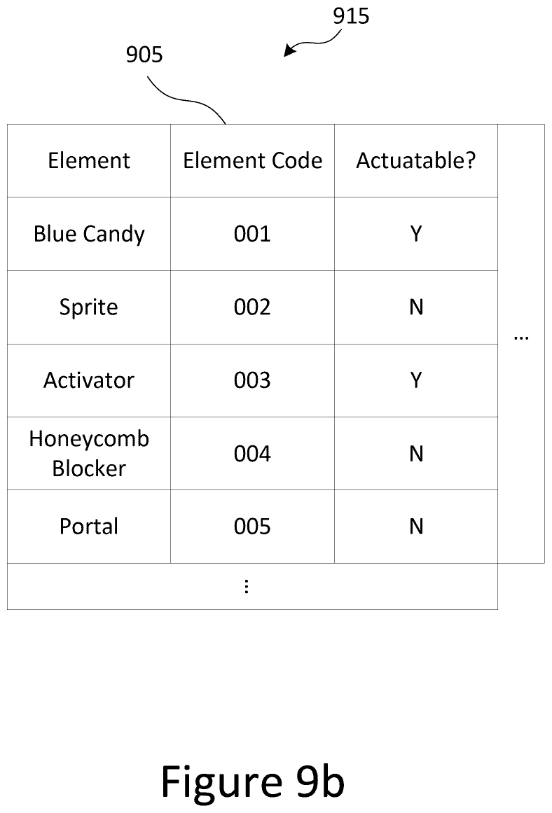

The grid component 80 stored in a memory provides a grid representation of the game board as shown schematically in FIG. 5. The grid component can be supplied by any suitable data structure, held in a local memory or remote memory accessible by the device, and is responsible for providing the game board layout. For example, the grid component may be supplied by a level data module 2518, as described later herein. As further described herein, the game board layout for each game level comprises game board locations which may define tiles. The grid component identifies each tile location on the game board and holds tile data including a tile ID and associated attributes about the game object supported by that tile and displayed at that tile location. For example, the grid component 80 may include data structures such as that of FIG. 9a, the data structure comprising data pertaining to tiles and their attributes, and data pertaining to activator elements and avatar paths. FIG. 9a is described in more detail later. These associated attributes may then be used in combination with other components and data in other data structures in order to control the rendering of the display, e.g. a match detector component 2510, and a refill mechanism component 2506.

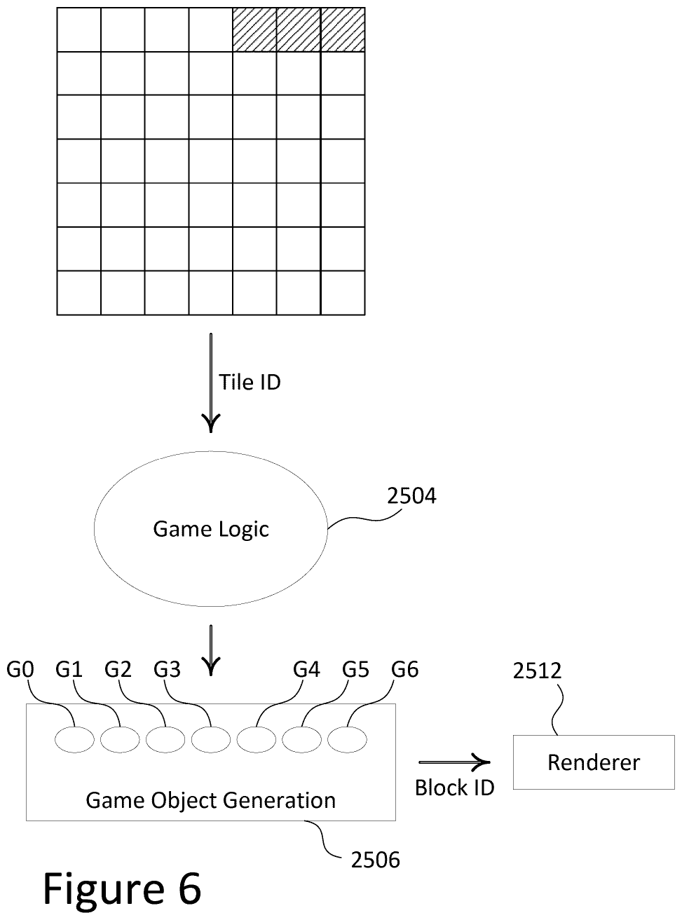

FIG. 5 further shows a rendering engine 2512 which, as described later with reference to FIG. 6, may be configured to control a display to render the game on a user/client device. A shown in FIG. 5, the grid 80 may cooperate with the rendering engine 2512 to provide a gameboard to the user.

Each game object has object attributes associated therewith. The terms game object and game element are used interchangeably throughout this document and no specific meaning is intended using one or the other unless the context suggests otherwise.

The object attributes may be stored in any suitable memory location. In some embodiments, the object attributes may be provided by a data structure. In some embodiments, the object attributes may be considered to be part of the game logic and in other embodiments may be considered to be outside the game logic. The object attributes may provide information as to the properties of a game object. These properties can include information of type/characteristic such as colour and/or whether or not a game object has a particular function such as a booster function or blocker function or, as newly described herein, an activator function.

The game logic 2504 determines the game objects selected by a user, and the actions to follow to implement the game mechanic. The following describes an implementation using a ‘switcher’ mechanic where groups of 3 or more matching game objects) are created when a user switches two adjacent objects and the resulting matching adjacent objects are automatically removed. In a switcher game, whether the colour and/or shape characteristics of adjacent elements match is determined by a match check. This check may be carried out for the whole gameboard where there are game elements. All game elements on the game board are match checked against the game elements immediately adjacent to them.

Alternatively, only some game elements on the gameboard are match checked. The game elements to be match checked may be determined by the location of user interaction with the gameboard, and/or the location of recent tile activity such as game element removal or game element refill. When multiple game elements are detected to have matching characteristics, a group of game elements is formed such that even game elements which are not directly adjacent to each other are included in the same group as long as they are connected in an adjacent manner via other game elements which also possess the same matching characteristic. In some embodiments, these groups of matching adjacent game elements may have to all be connected in one direction, i.e. they may have to be either vertically or horizontally connected. The match check is implemented after the player selects the two game elements to switch tile locations.

It will be appreciated that the device capable of providing the features described herein may be configured to provide a clicker game in which the qualifying match condition comprises two or more matching game elements, or a ‘linker’ game where game elements are dragged to form a match 3 or more condition.

The game logic controls the rules for determining if a valid match has been created for removal of the matched game elements from the gameboard. The game logic 2504 operates according to a set of rules of the level the user is playing. The game logic has access to data for each tile including its tile ID designating its location on the grid 80, and associated tile attributes providing information about the contents of that tile, e.g. the game object within that tile, at least one characteristic associated with the game object within the tile. The game logic 2504 is thus able to determine the game elements to be removed from those respective tiles for each user selection.

The physics engine component 2508 is configured to control the rendering of moving game objects in the display. The physics engine 2508 may be part of the game logic 2504.

A path module 2516 is configured to implement the avatar path functionality and game objective, as described herein. Further, the path module 2516 may perform such functions as: control the game logic 2504 to implement unlocking of a path tile or segment thereof when an activation condition is satisfied, and providing an indication of a visual attribute to assign to path tiles (locked and unlocked path tiles). In the latter case, the path module may enable the game logic 2504 to assign a first visual indicator to path tiles which are locked and a second visual indicator to path tiles which are unlocked, wherein the first and second visual indicators are visually distinct.

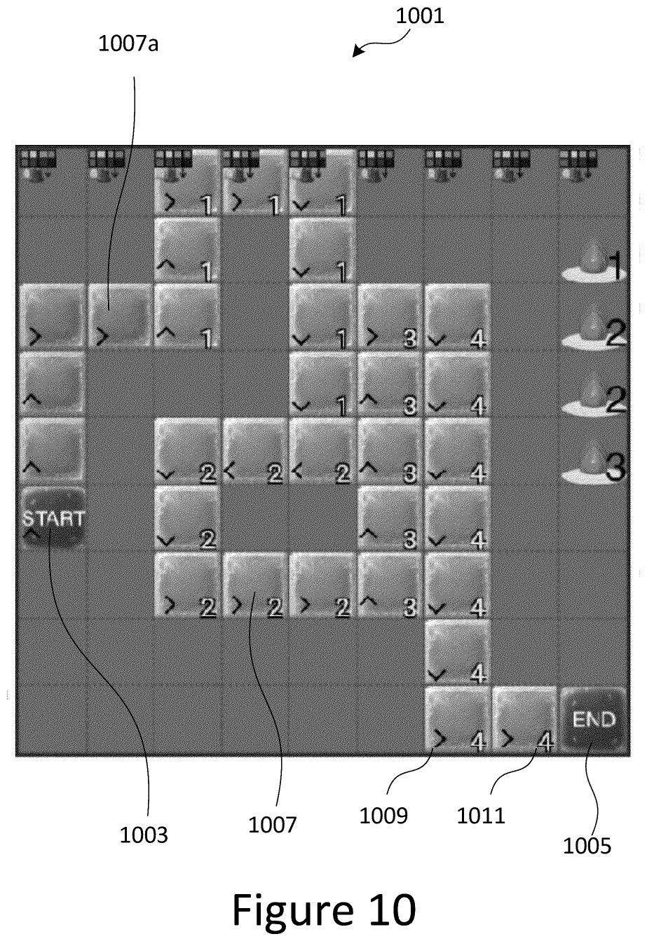

A level editor 2518 is a tool with which a game designer creates game levels. The level editor may receive user input defining a gameboard layout, level objective and other aspects of a game level. For example, a level designer may define the initial location of game elements within the level editor 2518. The level editor 2518 may output a file comprising computer readable instructions, including a data structure, which, when read, cause generation of a game level. The level editor 2518 thus outputs a data structure to be stored in memory of the grid component 80, providing predefined data for each level to the grid component 80, such as a gameboard layout. For example, the level editor 2518 may provide a predetermined layout of game elements to be placed in particular tiles of the grid. The level editor 2518 may further provide data pertaining to activator elements in a level including, for example, the position of the activator elements in tiles of the gameboard and a number of layers associated with each activator element. The level editor 2518 may further enable the avatar path to be defined. Level editing in context of the avatar path feature is described in more detail with reference to FIGS. 10-13.

### Element Generation and Refill

FIG. 6 is a highly schematic block diagram illustrating how gameboards are rendered visible to the user through a normal refill process. In the normal refill, the refill process may be set to random. In practice, the random refill process may be pseudorandom. As described earlier, each game level has a gameboard which is a layout of gameboard locations including tiles. Each tile has one or more tile attribute defined by tile data in the gameboard layout. FIG. 6 shows the gameboard layout in the form of the grid 80. The grid can be considered as a map which may be used to determine the relative positions of gameboard locations on the game board from the tile ID. The grid 80 shows an array of game board locations arranged in rows and columns. In FIG. 6, the grid 80 is shown with two dimensions, x and y. However, any alpha numerical designation can be used as the tile ID. No logical relationship between tile IDs is required. However, the grid position relationship between tile IDs may be determinable from the tile ID alone, e.g. by using an array of tiles with numbered rows and lettered columns.

As already explained, in order to render a gameboard on a display, each tile is associated with a game object to be rendered at that tile location. The nature of the game object, that is, for example, if it is a blocker or is playable (a normal game element or booster game element), or is an activator element, is determined by the tile attribute(s). The grid 80 is organised in sets S0 to S6. In this embodiment, each set represents a column of tiles in the array. However, sets may be organised in any appropriate manner. For example, they could be organised in rows or grids of tiles.

Shown in the tile grid 80 are three tiles T100, T200 and T300 which represent tiles where game objects may need to be spawned to replenish the gameboard. In a normal game refill process, new game objects are spawned in tiles that have an attribute associating them with playable (user interactable) game elements. A new game element is spawned into effect at an entry point of the set. For convenience, the endmost tile (in this case T100) can be considered the entry point for S6. However, any entry point for a set can be defined, and the precise entry point may depend on the orientation or shape of the set. Game objects are spawned into sets at their respective entry points. If the tile below the entry point is vacant, the spawned game object is moved down to that tile and then a further game object is spawned above it at the entry point. Note that sets may be of different configurations and spawned game objects may be moved to vacant tiles according to different refill physics.

Each tile of the grid 80 may be associated with data to indicate a status, such as filled or unfilled (empty/vacant) in relation to game elements. Thus, when the game board is refilled, each tile of the grid may be checked for such a status. Upon determining that there are tiles which are empty, the need to refill these tiles is recognised. Boolean logic may be used to determine whether a tile is to be refilled using the filled status of the tiles of the grid. The tiles must satisfy the condition of being unfilled in order to be refilled. As part of the refill mechanism, empty tiles are designated as the endpoint for particular game objects. This may be as the endpoint of a game element which is already in the game board and moving as a result of a game move due to the action of the physics engine 2508, or as the endpoint of a new game object entering the game board.

The game includes block generation logic 2506 which comprises a plurality of deterministic game element generating algorithms labelled G0 to G6. Each set is associated with a respective game element generating algorithm which spawns the new game element in a deterministic manner for its associated set. Game logic 2504 receives a tile identifier indicating a tile into which a game object is to be spawned. That is, the tile identifier indicates the set in which the tile belongs, and enables the entry point of the set to be indicated. This tile identifier enables the appropriate algorithm to be activated, and a game object identifier is generated by that algorithm to a renderer 2512 which controls a display 1318 on which the game board is presented to cause that game object to be inserted at the entry point. Within each set the process may be entirely deterministic. That is, game objects are provided in a predetermined sequence into the set, and moved through the set in a predetermined way. That sequence may be the same for all sets, or each set may have a different sequence. Alternatively, the game objects may be spawned in a random sequence. Randomly spawned game objects will still move through the set in a predetermined way, as dictated by the refill physics.

Each generator G0 to G6 can be controlled with a respective seed which then causes a pseudo-random sequence of game objects to be generated based on that seed.

The gameboard used in gameplay is defined by the grid 80. Attributes about the game objects occupying each tile of the grid are stored in association with the name, or ID, of the tile. This tile data may be stored in, for example, the tile data structure 901 (see FIG. 9a).

### Exemplary Avatar Path Game Flow

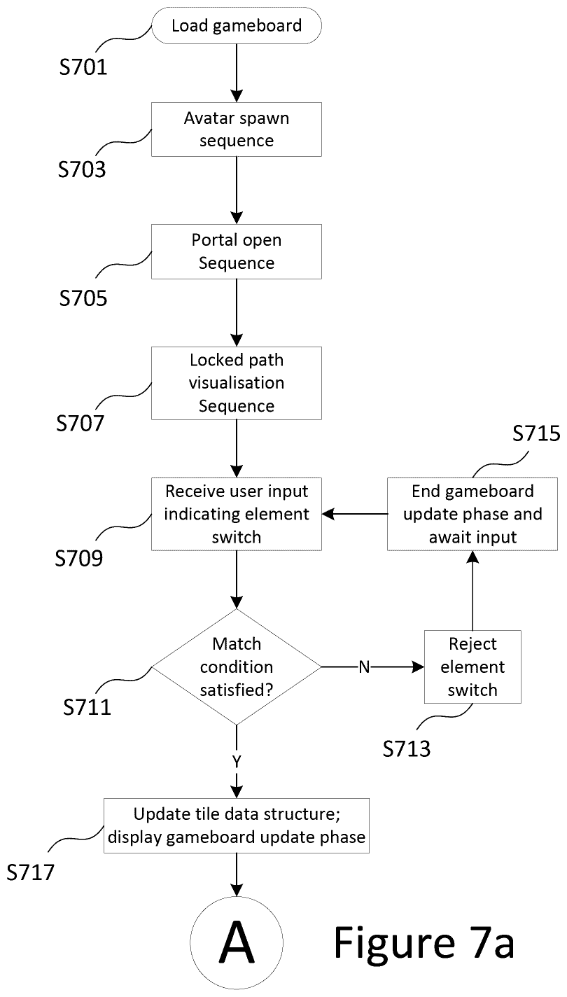

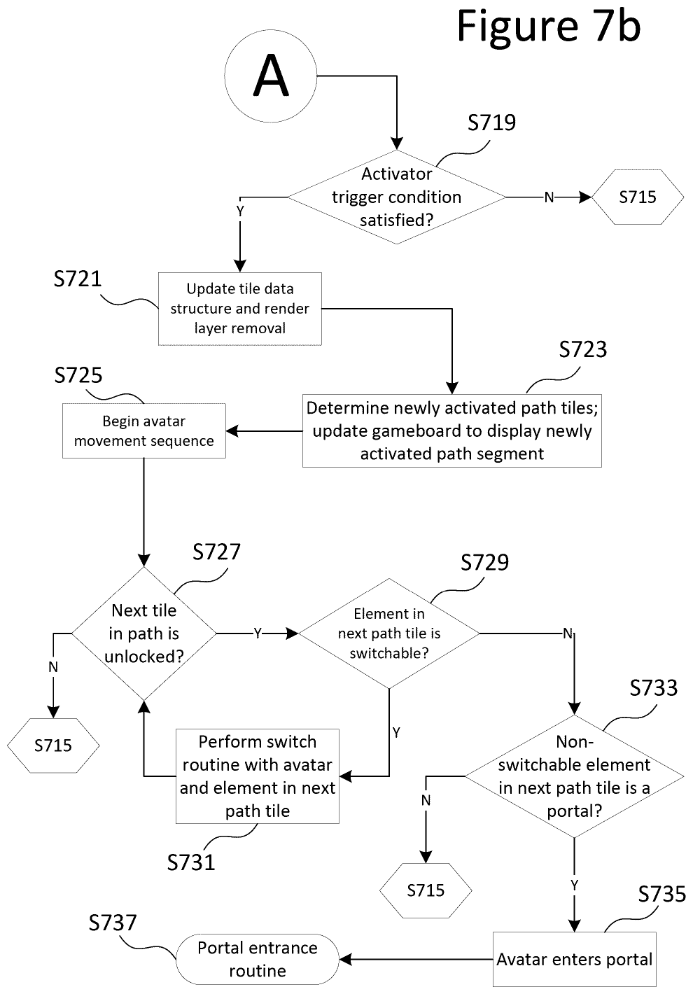

FIGS. 7a and 7b show a flowchart that represents an exemplary sequence of events that may occur during gameplay of a switcher game. The above ‘events’ represented by blocks of the flowchart in FIGS. 7a and 7b may represent user-initiated events, display events rendered on a display device, or back-end processing events in which game logic is executed to implement the avatar path feature described herein. It will also be appreciated that ‘determinations’ of certain criteria or conditions being met, as described in respect of FIGS. 7a and 7b, may in practice be made based on execution of game logic by a processor of the client device.

FIG. 7a includes steps S701 to S717, which represent a portion of the flow in which a level of a switcher game gameboard including the avatar path feature is loaded for play by a user, input is received, and a determination is made as to whether a match condition is satisfied.

In particular the flow of FIG. 7a begins at step S701, wherein a gameboard corresponding to a level of the switcher game is loaded. As mentioned above, the exemplary switcher game level implements the avatar path feature described herein. The gameboard may be rendered for display on a user interface with which the user may interact to control the game, e.g., via a suitable input mechanism using a suitable input device. The gameboard loading step S701 may include populating tiles of the gameboard with game elements, including booster, blocker and activator elements.

At a step S703 an avatar spawn sequence may occur, in which an animated sequence showing an avatar element being presented on the spawn tile of the avatar path may be displayed to the user.

At a step S703 a portal open sequence may occur, in which an animated sequence showing a portal element being generated on a portal tile (or path end tile) of the avatar path may be displayed to the user. Following step S703, the user is able to identify start and end points of an avatar path.

At a step S707 of the exemplary game flow, a locked path visualisation sequence may occur, in which a visual indicator may be applied to each tile on the gameboard that forms part of an avatar path, but which has not yet been unlocked. The visual indicator may allow a user or player to recognise the tiles through which the avatar must travel to reach the end of the avatar path.

Following step S707, the user is able to see a layout of game elements, a start tile and end tile of an avatar path, and tiles of the path through which the avatar will pass upon unlocking segments of tiles within the avatar path. The user may use the gameboard layout and visual indications of start tile, end tile, and locked path tiles shown after step S707 to make informed decisions on in-game moves. I.e., the visual indications of the avatar path and its start and end points may enable a user to strategise and identify a suitable in-game move.

At a step S709 a user input is received, the user input indicating that a user is attempting to switch a first game element in a first tile with a second game element in a second tile, the second tile being located in an adjacent tile relative to the first tile. Completion of step S709 may indicate the start of a gameboard update phase—a display animation phase that renders the result of a most recent user input, and in which the user interface on which the game is provided may be unresponsive to further user input.

At a next step S711, in response to receiving the user input at step S709, a determination may be made as to whether a match condition is satisfied. That is, step S711 may include an assessment regarding whether a match condition resulting in removal of a matched set of game elements would be triggered if the first element in the first tile were switched with the second element in the second tile. Note that the first and second tiles referred to here are the same as those referred to in respect of step S709.

If it is determined that a match condition is not satisfied by the input provided by the user at step S709, the flow continues to a step S713, wherein the element switch indicated by the user input at step S709 is rejected and the gameboard is returned to its previous state before the input was received at step S709.

Following step S713 the flow may progress to a step S715, wherein the gameboard update phase ends and the game enters an input phase, in which a next user input is awaited. That is, S715 may lead back to step S709, wherein a next input is received.

If at step S711 it is determined that a match condition is satisfied, the flow progresses to a step S717, wherein the tile data structure storing element data and other tile data for each tile of the gameboard is updated to reflect the switch routine. Step S717 further includes a standard gameboard update phase in which matched elements are removed from the gameboard and, in some instances depending on the gameboard layout, booster elements may be activated, layers may be removed from layered elements that are adjacent to a match or affected by a booster element, and a refill routine may be performed. It will be appreciated that elements generated during a refill routine may cause further match conditions to be satisfied. Step S717 may be considered to have ended once no further refill routine is necessary, i.e., because all tiles comprise elements and no match conditions are satisfied. The flow of FIG. 7a is shown to enter block A, which represents a link between the second portion of the same flow shown in FIG. 7b.

FIG. 7b is a continuation of the same exemplary workflow as described in respect of FIG. 7a. That is, the flow of FIG. 7b continues from step S717 in FIG. 7a, wherein a gameboard update phase is displayed after a match condition is satisfied. FIG. 7b begins at a step S719, wherein a determination is made as to whether an activator trigger condition is satisfied. As described previously herein, an activator element may have an associated trigger condition, which may be satisfied if a qualifying match condition is satisfied; a match condition may be qualifying if the match involves an element in an adjacent tile relative to the activator element.

If it is determined at step S719 that no activator trigger condition is satisfied, the flow progresses to step S715, which is shown in FIG. 7a. That is, if no activator trigger condition is satisfied, the gameboard update phase is ended, e.g. by completing any refill routines and rendering an updated gameboard, and the system awaits a next user input. As shown in FIG. 7a, step S715 may be followed by receipt of a further user input at step S709.

Alternatively, if the determination at step S719 indicates that an activator element trigger condition is satisfied, the flow progresses to a step S721. At step S721, the result of the activator trigger condition being satisfied may be updated in the tile data structure, e.g. reflecting the removal of a layer from the activator element or destroying the activator element. A display sequence corresponding to layer removal or removal of the activator element is also performed at step S721.

At a step, S723, a locked path segment comprising one or more locked path tile is identified for unlocking, based on the activator trigger condition being satisfied at step S719. Step S723 may comprise a display routine in which the tiles within the newly unlocked path segment are updated from having a visual indicator indicating the tiles are locked path tiles, to having a different visual indicator indicating that the tiles are unlocked path tiles.

It will be appreciated that in certain embodiments an activator element is not associated with any particular path tile or segment thereof. Path tile segments may be unlocked sequentially based on an unlock order defined at a level design stage. Satisfaction of any activator trigger condition, made in respect of any activator element on the gameboard, may cause unlocking of a next path segment, according to the predefined segment unlock order.

In some embodiments, a plurality of paths may be provided on the gameboard. In such an embodiment, an activator element may be associated with a particular one of the plurality of paths. In examples where multiple paths are provided, other avatar path features, such as segmentation of the path and sequential construction (segment by segment), may still be implemented.

At a step S725, following the unlocking of at least one path tile in a newly unlocked path segment, an avatar movement sequence may begin. Subsequent steps S727-S737 represent steps of an exemplary avatar movement sequence, though the decision blocks and links between processes mean that the workflow of FIGS. 7a and 7b is generic in context of some embodiments of the present description.

Step S727 includes a determination of whether a next path tile in the avatar path, relative to the avatar element, is unlocked. If the next path tile is not in the unlocked state, the flow progresses to step S715 (described with reference to FIG. 7a).

If at step S727 it is determined that the next path tile is unlocked, the flow progresses to a determination of whether the element located in the next path tile is switchable; this step is denoted S729. That is, certain game element types, such as regular candy elements, may be responsive to user input to be switched in order for the user to create a match condition-satisfying arrangement of game elements on the gameboard. However, other game element types, such as blocker elements, are not responsive to user input indicating a switch. If a switchable game element lies in the next path tile relative to the avatar element (given that the next path tile has already been determined to be unlocked at step S727), the flow continues to a step S731, in which the avatar element switches places with the element in that next path tile. Note that this is automatic, that is without direct user input—it occurs responsive to unlocking of the path segment. After step S731, the flow returns to step S727 and the determination of whether a new next path tile relative to the avatar element's new tile position is unlocked. It will be appreciated that the loop formed by steps S727-S731 indicates that an avatar element will automatically move along the avatar path, switching places with successive game elements in successive next path tiles, so long as the next tile is in an unlocked state and the game element located in the next path tile is switchable.

That is, the avatar element automatically progresses along the avatar path by switching places with elements lying on successive path tiles of the avatar path until a next path tile relative to the avatar element is determined to be locked, or until an element lying in a next path tile is not switchable. Steps S733-S737 represent the steps taken in a scenario where the element in the next path tile is non-switchable.

If at step S729 it is determined that the element in the next (unlocked) path tile relative to the avatar element is not switchable, the flow progresses to step S733. Step S733 includes a determination of whether the non-switchable element in the next unlocked path tile is a portal element. If the determination of step S733 returns that the non-switchable element is not a portal element then the flow returns to step S715; the game logic may infer from such a determination that the non-switchable, non-portal element is a blocker element, and that the avatar element cannot switch tiles and progress along the avatar path. This is consistent with the above statement that the avatar element automatically progresses along the avatar path by switching places with elements lying on successive path tiles of the avatar path until a next path tile relative to the avatar element is determined to be locked, or until an element lying in a next path tile is not switchable.

More generically, the avatar element may be caused to move along a path segment, extending from a current avatar location to a next location on a predetermined path, when that path segment is determined to be in a first state. It will be appreciated that determination of the ‘first state’ may be multi-faceted. For example, the determination may include checking that the segment is unlocked and that there are no non-actuatable blocking elements on the unlocked path segment. It will be appreciated that other conditions may be included in the determination of a segment being in a first state.

It should be appreciated that portal elements, which indicate the end of an avatar path, may be non-switchable elements according to the tile data structure. However, the avatar element automatically enters a portal element when a tile comprising the portal element is a next path tile relative to the tile comprising the avatar element. The avatar element should not stop short of the portal element because it sees the portal as a non-switchable blocker element. The game logic must therefore distinguish portal elements from other non-switchable blocker elements such that the avatar element moves into the portal element, hence the portal element determination step in S733.

If step S733 returns that the non-switchable element is a portal element, the flow progresses to a step S735, in which the avatar enters the tile comprising the portal element. S735 is followed by a final step S737 in the exemplary workflow, in which a portal entrance routine is performed. The portal entrance routine may include a visual display sequence in which the avatar element is shown to jump into or otherwise enter a portal represented by the portal element. A portal entrance routine may also include one or more additional sequence, such as a game completion sequence in which the user is notified that the avatar path objective, and thus the game level, is complete.

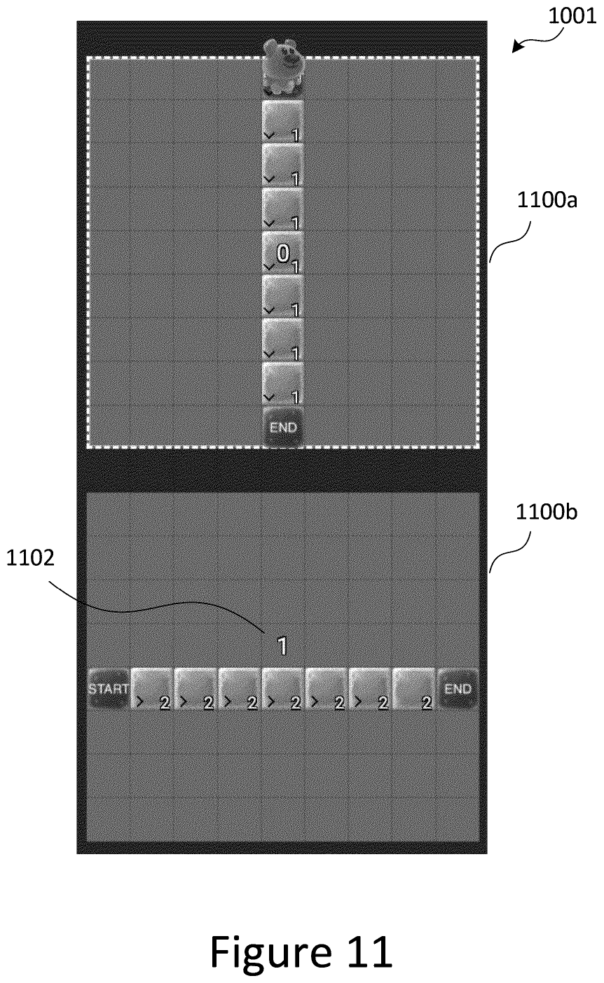

A portal entrance routine may also cause a next part of the same level to be loaded. That is, a single level in the game may comprise one or more avatar path objectives. Upon entering a portal corresponding to a first avatar path on a first gameboard, a second gameboard of the same level may be loaded, the second gameboard also comprising an avatar path objective. It will be appreciated that in such an embodiment, the flow may continue from the portal entrance routine of step S737 back to step S701 of FIG. 7a. That is, the workflow of completing the second gameboard of the level may be conceptually identical to that of the first gameboard. Reference is made to FIG. 11, which is described in more detail later herein, but which illustrates a game level design interface in which a multi-gameboard embodiment comprising the avatar path feature is being designed.

### Exemplary Game Level

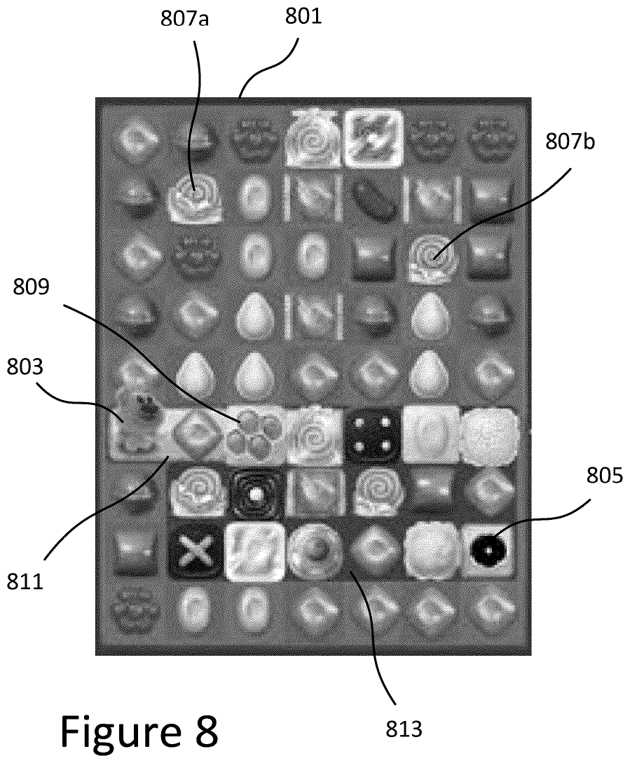

FIG. 8 shows an exemplary gameboard 801 for a level of a switcher game. The level represented by the exemplary gameboard 801 includes an avatar path objective according to certain embodiments described herein. In the example of FIG. 8, the gameboard 801 is shown in an initial state; e.g., a state in which user input is awaited and no previous user input has been received. The state of the gameboard 801 may correspond in some embodiments to the state of a gameboard following step S707 of FIG. 7a.

The exemplary gameboard 801 of FIG. 8 comprises a 7×9 grid of tiles. For the purposes of the following description of FIG. 8, the notation Txy will be used to denote a tile on the gameboard 801 located x tiles from the left and y tiles down from the top. For example, the game element of FIG. 8 denoted 807b lies on tile T63 according to the above-defined labelling system.

The gameboard 801 includes an avatar element 803, which may behave in accordance with the description provided above during gameplay. The avatar element is shown to be located at a tile T16. T16 therefore represents a spawn tile of the avatar element on the gameboard 801.

The gameboard 801 further includes a portal element 805, located at a tile T₇₈. As described previously herein, an in-game objective of the user may be to unlock avatar path tiles such that the avatar element can progress along the avatar path to the portal element 805. The portal element 805 may be provided on the gameboard 801 as an unswitchable element.

The reader's attention is now directed to two exemplary activator elements 807a and 807b, respectively located at tiles T22 and T63 of the gameboard 801. Note, however, that other activator elements are shown on the gameboard 801 of FIG. 8. The visual representation of activator element 807a on the gameboard 801 is distinct from that of activator element 807b. That is, activator element 807a is represented by a half-wrapped candy sprite. By contrast activator element 807b is represented by a sprite showing an identical candy element, but with less wrapping. The different visual representations of the activator elements in FIG. 8 represent a different number of layers associated with the respective activator element. That is, a particular activator element may comprise one or more layer. One layer of an activator element may be removed on satisfaction of a qualifying match condition or removed by direct interaction such as from a booster element.

Removal of a layer from an activator element may cause a change in the visual representation of that activator element. An activator element may be removed from the gameboard when all associated layers are removed. By way of example, activator element 807a may be visually modified such that it has the same representation as activator element 807b upon completion of a qualifying match condition; i.e., one involving a tile adjacent to the activator element 807a. That is, the visual representation of activator 807a may correspond to an activator element that has one more layer than activator 807b.

The gameboard 801 further comprises a blocker element 809, shown in tile T36 of the gameboard 801. The blocker element 809 may be an unswitchable element which is unresponsive to user input indicating a switch involving the blocker element. However, the blocker element 809 may be removed from the gameboard upon satisfaction of a qualifying match condition; e.g., a match including an element located in a tile adjacent to the tile comprising the blocker element 809. Note that the blocker element 809 may comprise one or more layer, and removal of the blocker element 809 from the gameboard 801 may require one or more corresponding qualifying match condition to be satisfied for the blocker element 809 to be removed from the gameboard 801. Note also that blockers/blocker layers may be removed in other ways, for example by direct interaction with a booster element.

The exemplary gameboard 801 of FIG. 8 shows an avatar path comprising a plurality of tiles on the gameboard 801. As mentioned earlier herein, an avatar path may be divided into segments, where one segment of the avatar path may be activated or unlocked each time an activator trigger condition is satisfied. Distinct visual indicators may be assigned to tiles comprised in a path segment that is unlocked, compared to tiles comprised in a path segment that is locked. However, both the unlocked path tile indicator and locked path tile indicator may both be visually distinct from a default visual indicator of a tile on the gameboard 801.

Reference numeral 811 of FIG. 8 points to an exemplary visual indicator that is assigned to path tiles that are unlocked. It will be appreciated that the unlocked path tile indicator 811 assigned to unlocked path tiles, such as tile T₂₆, is visually distinct from a default visual indicator assigned to non-path tiles elsewhere on the gameboard, e.g., to tile T₁₁. Reference numeral 813 of FIG. 8 points to an exemplary visual indicator that is assigned to path tiles which are locked. Again, it will be appreciated that the locked path tile indicator 813 assigned to locked path tiles, such as tile T₅₈, is visually distinct from the default visual indicator and from the unlocked path tile indicator 811. For example, colours, textures, tile borders, edge markings and other visual effects such as a glowing effect may be applied to locked and unlocked path tiles to make them visually distinct from one another and from regular gameboard tiles.

During gameplay on an exemplary gameboard according to the one shown in FIG. 8, satisfaction of an activator condition of an activator element 807 may cause one or more locked path tile (e.g., in a locked path segment), having a locked path tile indicator 813, to be unlocked and visually modified, such that the one or more newly unlocked path tile has the unlocked path tile indicator 811.

In the example of FIG. 8, the avatar element 803 is located in a first tile T₁₆, which is adjacent to a second tile T₂₆ which is an unlocked path tile (based on indicator 811) and comprises a switchable element. During gameplay on a gameboard according to that of FIG. 8, the avatar element may be able to switch with the element on tile T₂₆. However, once the avatar element is located at tile T₂₆, the game element in the next path tile (T₃₆) is the blocker element 809, which is not switchable. As described previously, the avatar element 803 may not switch with the blocker element 809, even if the tile supporting the blocker element 809 is an unlocked path tile.

The above examples refer to a ‘next path tile’. Game logic may be capable of determining which path tile in an avatar path is a next path tile based on level data, configured for example in a level design phase, which indicates an order of path tiles in which the avatar element should attempt to switch elements and progress along the path.

### Data Structures

FIG. 9a shows an exemplary tile data structure 901 comprising tile data for a level of a switcher game. The exemplary tile data structure 901 may be stored in memory and accessible to the processor for rendering the level of the game in accordance with the data in the tile data structure 901. The tile data structure may be updated to reflect element position changes resulting from user input and refill mechanisms.

The tile data structure 901 may provide data to the rendering engine 2512 such that the data can be used to render a game on a gameboard presented on a user interface 26. The tile data structure 901 includes an entry 913 for each tile on the gameboard, each entry comprising a plurality of values for a corresponding plurality of attributes for the associated tile. Reference numeral 913 of FIG. 9a points to a dashed box surrounding an exemplary entry within the tile data structure 901. An ‘entry’ may therefore be understood as a column in the data structure 901 corresponding to a particular tile or gameboard location. Whether the data structure provides an entry for all gameboard locations or just tiles is dependent on the embodiment, as described in more detail below.

The exemplary tile data structure 901 of FIG. 9a shows a plurality of exemplary configurable attributes. Each entry 913 within the tile data structure 901 may provide a value in respect of each of the provided attributes. The rendering engine may use the data provided in a particular entry 913 of the data structure 901 to correctly render a corresponding tile on the gameboard, including an element to be comprised therein.

In some embodiments, an entry 913 in the data structure 901 may be provided for each gameboard location on the grid.

Game logic and data stored in the memory may be configured to associate a particular entry (corresponding to a tile) in the data structure 901 to a particular corresponding gameboard location.

A first attribute that may be assigned a value at each entry in the data structure 901 is a tile ID attribute 903. The tile ID 903 value for an entry 913 may act as a reference value for a corresponding tile (or gameboard location). That is, the rendering engine and game logic may perform operations based on data in the tile data structure 901. The correct data item may be retrieved from the tile data structure 901 by referencing a correct tile ID value.

A next attribute that may be assigned a value at each entry in the data structure 901 is an element code attribute 905. The value assigned at the element code attribute 905 for a particular entry 913 indicates an element type that is to be rendered at the corresponding tile on the gameboard during gameplay. In practice, the element code value provided for a particular entry 913 may specify a particular data record in an element database, the data record comprising rules, image files, behaviour logic and other data specific to the element type specified by the element code value. During gameplay, the rendering engine 2512 and game logic may retrieve rules and other data pertaining to elements in each tile in order to implement the predefined behaviour of each type of game element. This retrieval may be based on element codes specified for each tile in the tile database 901, and further based on data in the element database that define the behaviours and other characteristics (e.g., visual appearance) of each element type.

Reference is now made to FIG. 9a in conjunction with FIG. 9b. FIG. 9b shows an exemplary element database 915 such as the one outlined above. The exemplary element database 915 comprises data pertaining to all possible game elements that are assignable to a tile of a gameboard in the switcher game. For conciseness, only the element types corresponding to element codes specified in entries shown in FIG. 9a have been provided in the exemplary element database 915 of FIG. 9b. The element database 915 of FIG. 9b only shows the element code and a parameter whose values indicate whether each type of game element is actuatable, i.e., responsive to user input for switching. However, as indicated above, all behavioural attributes associated with each element type, such as but not limited to: special refill phase behaviour, special gravity logic rules, switchable or non-switchable (actuatable or not), initial number of layers, retrievable image files for rendering on the gameboard, and any other behaviour logic may be parametrised in an element database such as that of FIG. 9b.

In some embodiments, behaviour of the avatar element may be parametrised in an element database such as is shown in FIG. 9b. However, in other embodiments, the avatar element behaviour may be defined in a separate data structure comprising game logic, visual data, and other data necessary for implementing an avatar element.

The tile database 901 comprises data that relates to an actual game level, and, as described earlier herein, may be updated each time a match condition is satisfied, or any time a substantive change occurs in respect of a game element or its position on the gameboard. By contrast, the element database 915 may define invariable templates of element types that may be provided on a gameboard.

The exemplary tile data structure 901 of FIG. 9a comprises attributes such as: a path tile attribute 907, a path segment index attribute 909, and a layer counter (remaining layers) attribute. The above list of tile attributes that may be configured in a tile data structure 901 is not exhaustive, but provides exemplary attributes that are relevant in context of the avatar path feature described herein.

Values specified in the path tile attribute 907 of a particular entry 913 may reflect an avatar path configured on a gameboard in a level design stage, which is described in more detail later with reference to FIG. 10. A path tile attribute 907 value of ‘0’ may indicate that the corresponding tile is not a path tile. A non-zero integer value may indicate that the corresponding tile is a path tile, and the magnitude of that non-zero integer value may indicate the position of that tile in an order in which the avatar element traverses the avatar path. For example, the tile with tile ID T₁₁ is not a path tile because its path tile attribute value is zero. By contrast, the tiles with tile IDs T₁₆, T₃₆, and T₇₈ have respective path tile attribute values equal to 1, 3 and 19, indicating that they are path tiles in the 1^{st}, 3^{rd} and 19^{th} respective positions on the avatar path.

Those skilled in the art will recognise that other systems for defining path tiles may be implemented. For example, the path tile attribute may be a Boolean value indicating a path tile or not a path tile; an additional path order attribute (such as an indicator of direction) may then be configured as a separate attribute in the tile data structure.

The tile data structure 901 of FIG. 9a further comprises a path segment index attribute 909. As described herein, path tiles may be unlocked one-by-one, or in groups of one or more path tile at a time, wherein each unlocking event corresponds to an activator trigger condition being met. Each tile may be assigned a value for the path segment index attribute 909 indicating a path segment to which that tile belongs, and the number of activator trigger conditions that need to be satisfied for that tile (and other tiles in the same segment) to be unlocked.

Tiles which are not path tiles may be assigned a value of zero in the segment index attribute. Entries 913 for path tiles having an integer value assigned in the segment index attribute 909 may be updated (e.g., decremented) each time an activator condition is satisfied in game, until the segment index value reaches a critical value. One or more path tile in a path segment may become unlocked and be displayed a such on the gameboard when their corresponding segment index is decremented to the critical value.

Alternatively, a globally applicable index counter, which is independent of the tiles on the gameboard, may be stored in memory. The index counter may be updated, e.g., incremented, each time an activator trigger condition is satisfied. In such an embodiment, values of the path segment index 909 in the tile data structure 901 may be static (i.e., not updated or modified when an activator trigger is satisfied). Instead, a comparison operation may be performed to assess whether the path segment index 909 value for any entries 913 in the tile data structure 901 is less than or equal to the global index counter value. That is, if the global index counter is incremented each time an activator element is triggered, a segment of one or more path tile should become unlocked once the global index counter is equal to or exceeds the segment index value of that path segment.

Spawn and portal tiles may be defined as path tiles, but may not require unlocking by satisfying one or more activator trigger condition. Unique values of the path segment index attribute 909, indicating spawn and portal tiles, may be defined in the tile data structure 901. An entry 913 comprising a spawn or portal value in the path segment index attribute 909 may indicate that the tile corresponding to that entry 913 is a path tile, but does not require unlocking.

Further, the spawn and portal values may indicate additional game logic. That is, a spawn value at the segment index attribute 909 may indicate that an avatar element should be rendered at a corresponding tile upon loading the game level. A portal value at the segment index attribute 909 may indicate a portal entrance routine is to be performed when the avatar reaches a corresponding tile. The portal entrance routine may include, for example, an endgame routine or a routine in which a next part of the same level is loaded (as described with reference to step S737 of FIG. 7b). Other portal entrance routines may be configured.

Whilst the tile data structure 901 may comprise additional configurable attributes, a further attribute shown in the example of FIG. 9a is a remaining layers attribute 911. As explained above, the element database 915 may be static or invariable, and may not be updated based on in-game events. Therefore, the tile data structure 901 may comprise a variable ‘remaining layers’ attribute 911 configured to track a number of remaining layers of an element based on events (i.e., layer removal triggers) that occur during gameplay. Values in the remaining layers attribute 911 may, upon first loading the game level, be equal to the default number of layers for the element comprised in the corresponding tile. That is, an initial value in the remaining layers attribute 911 of a particular entry 913 in the tile data structure 901 may be based on a default number of layers defined in the element database 915 (FIG. 9b) for the element type indicated by the element code value of the entry 913.

A value in the remaining layers attribute 911 of a particular entry 913 may be decremented upon satisfaction of an activator trigger condition. When the remaining layers value is decremented to a critical value, e.g., 0, the corresponding element may be removed from the gameboard.

Note the tile data in the exemplary tile data structure 901 corresponds to the configuration of elements shown in FIG. 8. That is, the path tiles and element types etc. shown in FIG. 8 are consistent with the data shown in the tile data structure 901 of FIG. 9a, in view of the element database 915 of FIG. 9b.

### Level Design

FIG. 10 shows an exemplary level design interface 1001 which may be used by a level designer user to configure a level of a switcher game in which the avatar path feature described herein is implemented. The level design interface 1001 shows a representation of a gameboard comprising gameboard locations which may be assigned as tiles to support game elements. In the example of FIG. 10, an avatar path is being configured, and the level design interface 1001 includes visual indicators representing aspects of the configured avatar path.

The game design interface comprises a start tile 1003 and an end tile 1005. The respective tiles in which the start 1003 and end 1005 tiles are located may have been selected by the level designer user on the interface 1001 to define a respective start and end tile of the avatar path.

The design interface 1001 further shows a plurality of path tiles 1007, each path tile 1007 being visually distinct on the interface 1001 compared to tiles or gameboard locations on the interface 1001 which have not been selected as path tiles 1007.

Each path tile 1007 on the interface 1001 comprises a direction indicator 1009. The direction indicator 1009 of a particular path tile 1007 may indicate a direction in which a next path tile is located. A next path tile relative to a first path tile may necessarily be an adjacent tile relative to the first path tile. Therefore, the direction indicator 1009 of a first path tile may indicate a second, adjacent path tile, wherein the second tile is the next path tile relative to the first tile. The direction indicator may be explicitly assignable by the level design user via the design interface 1001.

Each path tile 1007 may further comprise a segment index value 1011. The relative magnitudes of segment index values 1011 of the path tiles 1007 may indicate an order in which the path tiles (or segments thereof) are unlocked during gameplay. In some embodiments, the segment index value 1011 of a particular path tile 1007 may explicitly designate a number of activator trigger conditions that must be satisfied for that path tile (and any other path tiles having the same segment index value 1011) to be unlocked during gameplay.

It will be appreciated that a path tile 1007 may be considered to be in a path segment with one or more other path tile 1007 by nature of having a same path segment index 1011.

Reference numeral 1007a denotes an exemplary path tile on the design interface 1001. The exemplary path tile 1007a does not comprise a segment index value 1011. This may indicate that that path tile 1007a does not need to be unlocked, and may be automatically unlocked upon loading the level. In embodiments there this tile property is implemented, the tile data structure, such as the structure 901 of FIG. 9a, may include data that reflects the corresponding tile behaviour.

### Additional Features

FIG. 11 shows first and second regions 1100a and 1100b of an exemplary level design user interface 1001, in which a multi-gameboard level is being designed; the level comprises the avatar path feature described herein.

The first and second regions 1100a, 1100b, each comprise an avatar path, each avatar path being defined by a start tile, an end tile and intermediate path tiles having a direction indicator and a segment index, in accordance with the description of FIG. 10. The end tile of the path in region 1100a may have an associated portal entrance routine that, during gameplay, causes a second gameboard of the same level to be rendered on the user interface, the second gameboard corresponding to the second region 100b of FIG. 11. Each region 1100a, 1100b on the design interface 1001 of FIG. 11 comprises a gameboard index 1102, wherein the gameboard index indicates an order in which multiple gameboards, corresponding to the multiple regions 1100a, 1100b, are to be rendered first during gameplay. Region 1100a includes gameboard index ‘0’, and region 1100b includes gameboard index ‘1’.

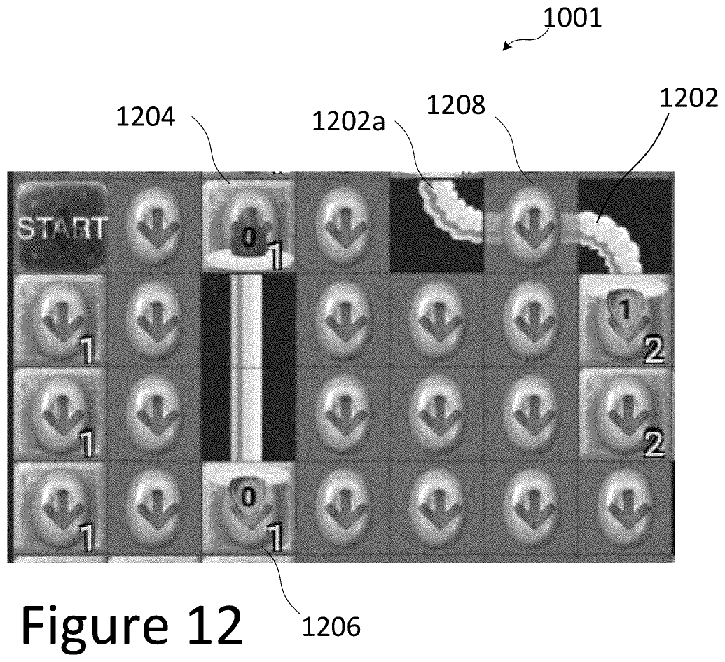

FIG. 12 shows an exemplary game design interface 1001 comprising a plurality of so-called straw or tube elements 1202, which may be implemented according to some embodiments. Straw elements may form a static part of an avatar path, through which the avatar may travel without switching tile places with the tube element. That is, tube elements may be non-actuatable elements on the gameboard that are defined as part of the avatar path, but which can be traversed by the avatar element in-game. In embodiments according to the above and FIG. 12, attributes within the tile data structure may enable the user to define a non-switchable element that the avatar element can still pass through, as is required to implement the above feature.

One or more tube element 1202 may be positioned on the gameboard. A tube section may comprise one or more successively adjacent tube element 1202, and may be defined at the extremes by a tube start indicator 1204 and a tube end indicator 1206, as shown in FIG. 12. In examples where a plurality of tube sections are defined, the respective start indicators 1204 and end indicators 1206 of each section may include a tube section index defining which section that indicator belongs to. This may ensure that the avatar element correctly exits the same tube section it enters.

Tube elements may include a direction indicator, as described with reference to FIG. 10, indicating a direction of avatar travel through tube elements on the avatar path. A visual appearance of a first tube element on the gameboard may be based on a direction indicator of the first tube element, and a direction indicator of a second path tile, wherein the second path tile is an immediately previous path tile in the avatar path. For example, exemplary tube element 1202a visible bends from a top edge to a right-hand edge of its host tile; note also that the avatar travels into the tube element 1202a from the top, exiting at the right-hand side. The visual appearance of tube element 1202a may be selected based on a determination that the tile hosting element 1202a indicates a right-hand direction, whilst the tile immediately above tile 1202a (the previous tile in the path, which is not shown in FIG. 12) has a direction indicator pointing down towards element 1202a.

In some examples of the tube element embodiment described above, a tube element forming part of the avatar path may co-exist with a standard game element—e.g., a candy, booster, or blocker element—on the same tile. For example, reference numeral 1208 denotes a tile which comprises a tube element 1202, but also includes a standard game element. In such an example, special game logic and data in the tile database may allow the standard game element to be responsive to user input and to be moved or destroyed etc. during gameplay, whilst the co-existing tube element in the same tile remains static and non-actuatable.

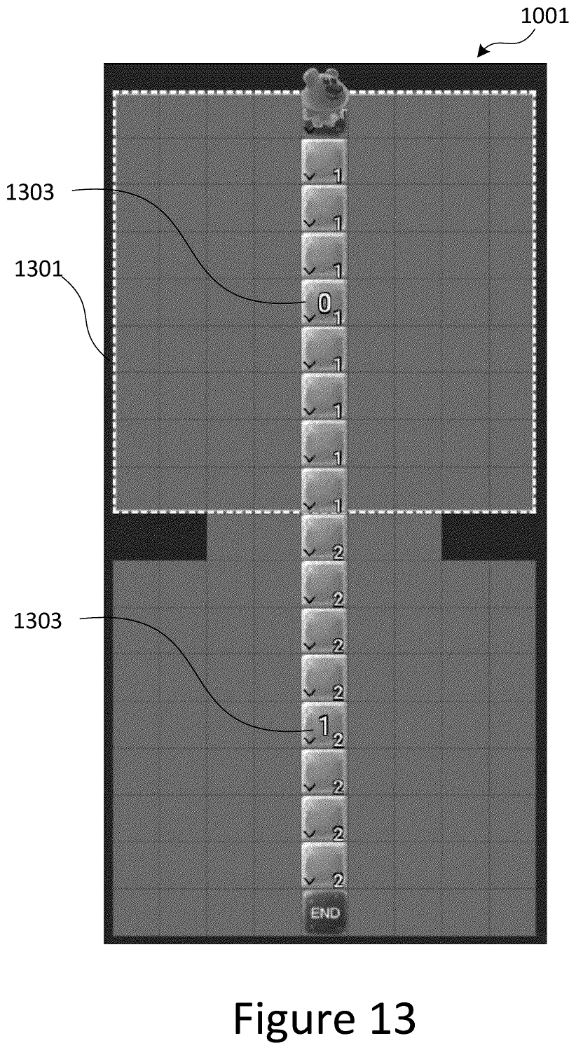

FIG. 13 shows another embodiment of a level design interface 1001 and demonstrates a further aspect of the avatar path feature, according to some embodiments. FIG. 13 shows an exemplary ‘camera change’ routine. In such an embodiment, once the avatar reaches a particular tile, a camera view changes to reveal a next portion of the same gameboard, through which the avatar must also travel to complete the avatar path and thus the game level objective.

FIG. 13 shows a dashed region 1301 representing a first camera region, which may be a first camera view region displayed to a user during gameplay. Upon satisfaction of a camera change condition, the camera view may reveal the rest of the gameboard, which may be the portion of the gameboard in FIG. 13 not encircled by the dashed region 1301.

The camera change condition may be associated with a particular path tile, such that the camera change routine is performed once the avatar element reaches a particular tile on the gameboard, where that particular tile is within the scope of the first camera region 1301. It will be appreciated that a camera change may be implemented when the avatar reaches a particular tile, not when a particular segment is unlocked. That is, in some embodiments, a single path segment may pass from a first camera view through to a second camera view, but the camera view may not change until the avatar moves to a tile at the boundary of the first camera view.

FIG. 13 shows an exemplary camera view index 1303 which may be assignable to define an order in which the plurality of respective camera views is provided to the player in-game.

It will be appreciated that the camera change routine is not a portal entrance routine because the camera change condition is not activated when the avatar element reaches a portal element. The presently described camera change routine is therefore distinct from the multi-gameboard embodiments described with reference to FIG. 12.

### Booster and Blocker Elements Glossary

The game mechanics of the above-mentioned booster elements are described below in a glossary which is intended as a non-exhaustive list of game elements.

Standard game elements: These are the six basic candies used for making switches and colour matches on the game board. Compared to special game elements, the standard game elements have no extra properties or behaviour, they are only used to make colour combinations or to create new special game elements.

Striped candy: A special candy with a line blast effect which means it removes one row or one column.

Line blast: An effect which removes one row or one column.

Wrapped candy: a candy in wrapped paper which removes candies in a 3×3 square area.

Colour Bomb: removes all candies of the colour with which it is being swapped.

Fish elements have a colour and must be included in a corresponding colour match to be activated. When activated, a quantity of other game elements of the same colour as the activated fish are removed from the gameboard.

Jelly cake is a blocker element, which provides a destructive booster effect upon its removal from the gameboard. Jelly cake blockers occupy a 2×2 region of tiles. The blocker is removed after a predetermined number of qualifying matches adjacent to the jelly cake. When jelly cake is destroyed, all removable game elements on the game board are activated (e.g., removed or decremented by 1 layer).

It will be appreciated that, whilst specific embodiments of the invention have been described, these are not exhaustive. The scope of the invention is not defined by the described embodiments but only by the appendant claims.

1. A computer device configured to provide a computer game responsive to user inputs, the computer device having:
a user interface comprising a display which is configured to display an initial game board of the computer game comprising user actuatable game elements and a user input detection component configured to detect user input of a user move when a user engages with one of the user actuatable game elements, the display further configured to display an avatar element at an initial avatar location of the game board, and at least one activation element on the game board;
a processor configured to receive the detected user input of the user move and to detect an activation condition from an interacting event with the activation element and, responsive to the detection of the activation condition, to unlock a path segment extending from the avatar location to a next location on a predetermined path;
the processor further configured to determine that the path segment is in a first state which permits movement of the avatar element from the avatar location to the next location, and to cause the avatar element to move from the avatar location to the next location without detecting further user input.

2. The computer device of claim 1 wherein the processor is configured responsive to the detected user input of the user move to detect a match game condition of at least three adjacent matching user actuatable game elements and to control the user interface to remove the at least three game elements from the display and provide on the display replacement user actuatable game elements.

3. The computer device of claim 2 wherein the processor is configured to detect an interacting event with the activation element which comprises a match game condition of user actuatable game elements at least one of which is adjacent the activation element.

4. The computer device of claim 1 wherein the processor is configured to detect an interacting event which is created by game code executed by the processor which generates a direct interaction with the activation element.

5. The computer device of claim 1 wherein the display is configured to display a second activation element and wherein the processor is configured to detect a second activation condition from an interacting event with the second activation element, the processor further configured to unlock a second path segment extending from the next avatar location to a subsequent avatar location and to move the avatar element from the next location to the subsequent location on determination that the second path segment is in the first state.

6. The computer device of claim 1 wherein the processor is configured to unlock path segments to form the predetermined path from the initial avatar location to an endpoint location of the predetermined path.

7. The computer device of claim 6 wherein the processor is configured to generate at the endpoint location of the predetermined path a portal on attainment of which by the avatar element a new game component is rendered on the display.

8. The computer device of claim 1 wherein the activation element comprises multiple activation layers, each of which is removed by an interacting event, wherein the activation condition is detected when all of the multiple activation layers have been removed.

9. The computer device of claim 1 wherein the processor is configured to render the predetermined path so as to be visually apparent on the display.

10. The computer device of claim 9 wherein an unlocked path segment has a different visual appearance from a path segment of the predetermined path that has not yet been unlocked.

11. The computer device of claim 10 wherein the processor is configured to render on the display an indication of a direction in which the avatar element will move from its current location to a next location.

12. The computer device of claim 8, wherein the processor is configured to render the activation element on the display with an appearance which differs on removal of layers from the activation element.

13. The computer device of claim 1 wherein the processor is configured to remove the activation element from the game board when the activation condition is met.

14. The computer device of claim 1 wherein the processor is configured to detect that the unlocked path segment comprises a user actuatable game element and to switch the location of the user actuatable game element on the unlocked path segment with the avatar element in order to move the avatar element along the path segment.

15. The computer device of claim 1 wherein the processor is configured to provide the replacement user actuatable game elements by a refill mechanism in which game elements adjacent the locations of removed elements in a direction determined by a predetermined physics move into the spaces left after removal of the elements and replacement user actuatable game elements are refilled from the edge of the game board according to the predetermined physics.

16. The computer device of claim 1 which comprises a computer store holding tile data for each of a plurality of tiles supporting the game elements, including one or more activation element of the game board, the tile data designating a tile location of each tile on the game board and an indication that tiles on the predetermined path constitute path segments.

17. The computer device of claim 16 wherein the tile data comprises attributes of the tile, wherein the attributes include one or more characteristic of a game element supported by the tile, wherein the game elements include one or more activation element.

18. The computer device of claim 1 wherein the processor is configured to determine that the path segment is not in the first state by detecting a blocker on the unlocked path segment.

19. The computer device of claim 1 wherein display of the initial game board of the computer game comprises displaying a first portion of the game board, and wherein the processor is configured to determine that the avatar element has moved from the avatar location to a boundary gameboard location at an extreme of the first portion of the gameboard and, in response, to display a second portion of the gameboard.

20. The computer device of claim 1, wherein the processor is configured to detect that a location on the unlocked path segment comprises an actuatable game element and a background tube element and to move the avatar element along the unlocked path segment without switching the location of the actuatable element.

21. A computer-implemented method of providing a computer game responsive to user inputs, the method comprising:
displaying, on a user interface of a computer device, an initial game board of the computer game comprising user actuatable game elements and detecting, via a user input detection component, a user input of a user move when a user engages with one of the user actuatable game elements;
displaying an avatar element at an initial avatar location of the game board, and at least one activation element on the game board;
receiving, at a processor of the computer device, the detected user input of the user move:
detecting, via the processor, an activation condition from an interacting event with the activation element;
responsive to the detection of the activation condition, unlocking a path segment extending from the avatar location to a next location on a predetermined path;
determining, via the processor, that the path segment is in a first state which permits movement of the avatar element from the avatar location to the next location; and
causing, via the processor, the avatar element to move from the avatar location to the next location without detecting further user input.

22. A non-transitory computer-readable medium on which are stored computer readable instructions which when executed by a processor of a computer device cause the processor to implement the method of claim 21.
